(19) United States
(12) Patent Application Publication
(10) Pub. No.: US 2003/0077360 A1
(43) Pub. Date: Apr. 24, 2003

(54) Drinking cup system

(76) Inventor: Joav Ramon, Woodland Hills, CA (US)

Correspondence Address: Marshall E. Rosenberg, Esq., The Gilbert Law Building, 22130 Clarendon Street, Woodland Hills, CA, 91367, US

(21) Appl. No.: 10/042,123

(22) Filed: Oct. 19, 2001

(51) Int. Cl. A23L 1/00

(52) U.S. Cl. 426/86

(57) ABSTRACT

A drinking cup system is disclosed that provides for the brewing of individual or group servings of a beverage utilizing an open, ingredient-supporting frame secured within the disposable drinking cup for holding a food substance such as instant beverage mix or flavoring. The frame is generally sized to support a quantity of the food substance proportioned to fully mix with a selected quantity of water or other mixing base to achieve a fully developed coffee brew or other mixture. For packaging purposes and according to the invention, the frame is adhered to, or alternatively integrally formed with the floor or lower wall portion of the drinking cup. According to another embodiment, the ingredient is loosely packaged or provided in tablet form to be received and secured under a sealing lid.

### BACKGROUND OF THE INVENTION

1. Field of the Invention

The present invention generally relates to containers and vessels for beverages, soups and other liquid-based foodstuffs, and more particularly to a drinking cup system for in situ preparation of a liquid-based foodstuff.

2. Description of the Related Art

It is frequently desirable to brew individual portions of a liquid-based beverage or other foodstuff such as coffee, tea, hot chocolate, and soup, without necessitating the use of large or bulky conventional brewing equipment, such as coffee pots, tea pots, or other cooking apparatus. This desire is especially acute in the fields of transportation including airline and automobile travel, office environments, job sites, sporting events, outdoor activities, or other venues in which it is desirable to have made available a ready source of beverage service including even home environments to provide a ready beverage system with a minimum of fuss and mess, although where space or other constraints prevents the introduction of suitable conventional cooking equipment. This desire is further felt in the fields of mass transportation, mobile food services, or other environments where conventional brewing equipment is not available due to location, inconvenience, availability of service personnel, or cost.

The related art is known to include various prepackaged pillows or pre-filled utensils for brewing a beverage without requiring anything other than hot water. For example, tea bags and tea infusers are well known and widely used in connection with a drinking cup or vessel, and are receptive to the addition of a mixing fluid such as water, milk or the like. In the case of powdered mixes, additives, flavorings and the like, a measuring utensil is also required for transferring the desired quantity of mix/additive from a bulk supply to the individual drinking cup or vessel. Thus, those related art apparatus requires supplying, in addition to the drinking cup or vessel, the necessary additional implement, device, or container containing the mix, additive, or flavoring, which may be provided in loose (powder, granular, or crystalline) form or contained in pre-packaging such as a tea bag or infuser for supporting and delivering the flavoring selected for use in connection with the mixing fluid and the beverage cup or other drinking vessel. Thus, it becomes necessary to stock drinking cups separate from, but in addition to the desired mix, and making both components available together with the mixing fluid.

A further problem is that once the beverage is mixed, a disposal issue arises with respect to the implement or device in which the mix, additive, or flavoring was measured, as well as the bulk container from which the mix was obtained. Typically, such implement is neither designed nor priced to be disposed of after a single use (whether for an individual portion or for multiple portions brewed with a single portion of the flavoring), and accordingly it would be prohibitively expensive to do so.

By way of example, the related art includes various well-known examples of packages and stirring implements for making individual serving portions of beverages. The implements may be provided in the form of a spoon having one or more compartments shaped to hold a beverage-making ingredient, such as dehydrated instant coffee, and a plurality of apertures are provided within the walls of the bowl of the spoon to permit the ingress of liquid when the spoon is immersed in a cup of water, such that the beverage-making ingredient may dissolve in the water to produce the desired beverage.

While such devices may be appropriate for their intended, albeit limited function, that is for producing a beverage by the introduction of the device into a liquid and the subsequent stirring therein, those devices fail to satisfactorily address and overcome the deficiencies described above. Such deficiencies center around the fact that a separate utensil is required for securing the mix or flavoring. Moreover, the combination of such separate utensil and a beverage container, even when each item is designed to be disposable individually, tend to be prohibitively expensive in combination. Just as importantly, such separate items together present a disposal problem due to an excessive amount of debris en toto, such as within the cramped quarters of an airliner or vehicle having finite garbage-storage areas, as well as in view of the potential negative environment impact when such items are distributed at venues attended by large numbers of consumers.

Accordingly, what is needed is an apparatus and system which overcomes these well known but heretofore unsolved issues in the related art. More particularly, what has been needed is an apparatus and system for providing individual portions of fresh brewed coffee or other beverage, soup, or other foodstuff, with a maximum of flexibility and a minimum of effort and waste all in connection with a single, disposable container.

### OBJECTS AND SUMMARY OF THE INVENTION

It is thus an object of the present invention to provide a drinking cup system that eliminates the need for conventional brewing equipment, yet provides on-site beverage service on-demand without incurring the packaging and refuse problems of the prior art.

It is another object of the present invention to provide a drinking cup system that makes available a ready source of beverage service, save only for the addition of water or other mixer.

It is a further object of the present invention to eliminate the prior art necessity of providing separate bulk supplies used in conjunction with separate measuring implements.

It is yet a further object of the present invention to provide a drinking cup system that successfully overcomes prior art problems related to storage and disposal of drinking cups, separate measuring utensils, as well as bulk mixes and flavorings required for use therewith, especially in connection with serving venues offering limited storage and disposal facilities.

It is yet a further object of the present invention to provide a drinking cup system that successfully minimizes to a single drinking cup system all of the components necessary to fully prepare a beverage for consumption, thus successfully and responsibly addressing related environmental issues.

The drinking cup system of the present invention meets these needs and achieves these results by providing for the brewing of beverage servings (either single or multiple portions) utilizing an open frame secured within the disposable drinking cup for holding a food substance such as instant beverage mix or flavoring, sized to hold single or multiple portions of the food substance proportionate to the capacity of the drinking cup. The frame is generally sized to support a quantity of the food substance necessary to mix with a full cup of water or other mixing base to achieve a fully developed coffee brew or other mixture. For packaging purposes and according to the invention, the frame is adhered to, or alternatively integrally formed with the floor or lower wall portion of the drinking cup. Alternatively, a loose supply of instant coffee or other food substance to be mixed may be received within the concavity of the drinking cup without the open frame.

A removable lid or seal may be received within the concavity of the drinking cup above or even supported by the frame to provide a sealed unit prior to individual use. Alternatively, a lip or one or more protrusions may be provided about the inner wall portion of the drinking cup to support the removable lid. In either embodiment, the removable lid or seal completely seals and protects the food substance, with or without a food-substance carrier frame, within the concavity of the drinking cup.

To minimize storage space requirements and maximize handling and dispensing capabilities, a plurality of such drinking cups of the present invention may be nested one inside the next in a stacked arrangement. The invention thus provides a fully integrated drinking cup and mix/flavoring system, thereby eliminating the prior art problems of separate bulk supplies used in conjunction with separate measuring implements, and further successfully address storage, dispensing, and environmental issues.

The invention will be better understood upon a reading of the following specification, read in conjunction with the accompanying drawings.

### BRIEF DESCRIPTION OF THE DRAWINGS

FIG. 1 is a perspective view of a first embodiment of the drinking cup system of the present invention, showing an open frame secured to the floor of a disposable drinking cup for holding a food substance such as instant beverage mix or flavoring.

FIG. 2 is perspective view of a second embodiment of the drinking cup system of the present invention, showing another embodiment of the open frame disposed on the floor of disposable drinking cup, further including a removable lid received within the concavity of the drinking cup to seal the lower concavity of the drinking cup and food substance-securing frame from the environment prior to use, together with a plurality of inwardly-extending tabs for supporting another drinking cup in nested relationship.

FIG. 3 is a perspective view of a third embodiment of the drinking cup system of the present invention, further showing an inwardly-extending rim disposed about the inner wall of the drinking cup for supporting a removable lid thereon.

FIG. 4 is a perspective view of the drinking cup system of the present invention, showing the open frame disposed on the interior floor of the drinking cup sized and shaped to support another like drinking cup in nested relationship to minimize the overall stacked height of a plurality of such drinking cups.

FIG. 4A is a perspective view of a plurality of drinking cups such as those shown in FIG. 4, arranged in stacked and nesting orientation, and a beverage contained in the upper drinking cup prepared according to the invention.

FIG. 5 is a perspective view of another embodiment of the invention, showing a loose ingredient for use therewith.

### DETAILED DESCRIPTION OF THE INVENTION

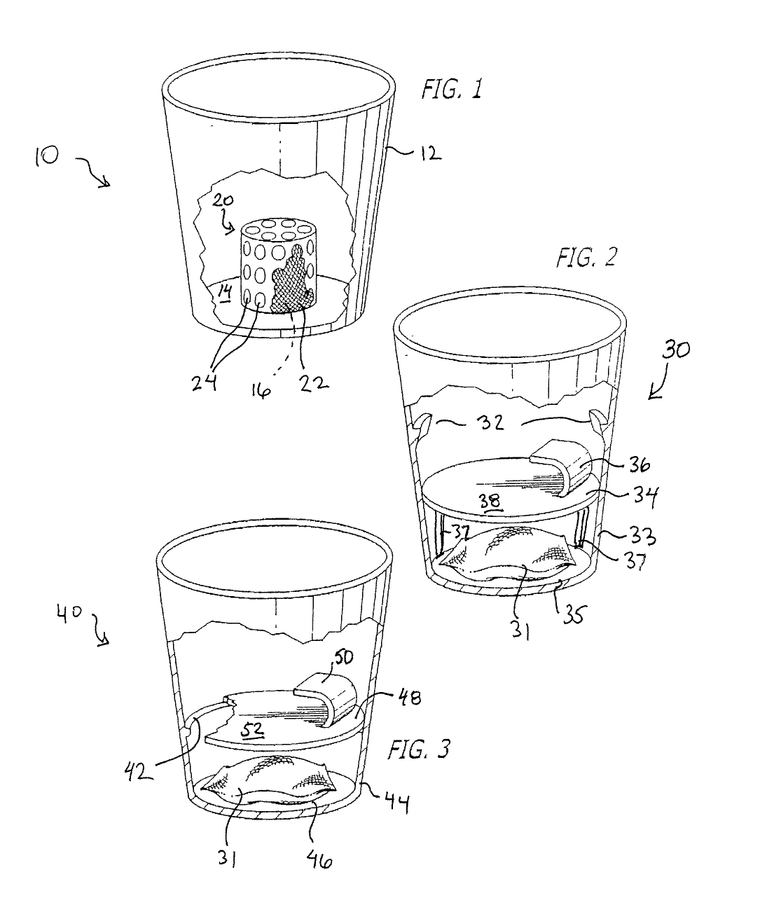

With reference now to the drawings, and according to the present invention, FIG. 1 illustrates a drinking cup 10 generally fabricated of fiberboard, cardboard, plastic, foam or other low-cost material as is well known in the related art and which is amenable to cost-effective disposal after a single use. The drinking cup 10 shown herein has a generally frustoconical shape with an upwardly and outwardly tapered sidewall 12 extending from and supported by a circular floor 14, although the drinking cup 10 may be fabricated with other shapes including cylindrical, rectangular or the like. It will be appreciated that drinking cup 10 will be fabricated of a material having an inherently waterproof construction, or alternatively, having a waterproof coating applied to the inner surfaces thereof. It will also be appreciated that the drinking cup 10 may be formed to contain a volume of liquid necessary and sufficient to satisfactorily achieve the objectives of the invention, i.e., to sufficiently mix with an ingredient 16 such as a mix, flavoring, or other additive secured within a frame or cage 20 secured to floor 14 of the drinking cup 10.

More particularly and according to one embodiment, volume enclosing frame 20 is deposited within and secured within the drinking cup 10 for holding the ingredient 16 such as an instant beverage mix or flavoring, including but not limited to individual serving portions of hot water-based coffee, tea, hot chocolate, or other such mixed beverages. Alternatively, the food substance may be an instant beverage mix or flavoring utilizing cold water as its basis, for beverages such as fruit or candy flavored drinks or the like. The expression “individual serving portion” as used herein is intended to cover a serving portion commensurate with the volume of the drinking cup 10, such that the invention may be utilized in connection with a mixing vessel intended for use in preparing a mixed beverage for a plurality of drinks of generally accepted serving size, and a corresponding quantity of the ingredient 16 required to prepare the selected volume of the mixed beverage up to the useful volume of the selected vessel will be accommodated within frame 20.

Accordingly, the frame 20 is generally sized to support a quantity of the food substance necessary to mix with a diluent such as a full cup of water, milk or other mixing base to achieve a single serving of a fully developed coffee brew, tea, cocoa or other mixed beverage. It will be appreciated that capacities may be increased to provide for a proportionate number of plural servings, and the capacity of the drinking cup 10 sized accordingly. For packaging purposes and according to the invention, the frame 20 is adhered to, or alternatively integrally formed with the floor or lower wall portion of the drinking cup. The frame 20 may be packaged together with or separately from the drinking cup 10, although it will be appreciated that inclusive packaging achieves the compact packaging objectives of the present invention and overcomes shortcomings of the related art as previously described.

Volume defining walls 22 of frame 20 include a plurality of apertures 24 formed therein to enable the infusion of the beverage-making food substance/ingredient 16 into the liquid during and after introduction of the liquid into the drinking cup 10. Apertures 24 may be provided as perforations, vents, slits, slots, or other means for allowing ingress of the mixing fluid, and outflow of the mixed beverage to the greater volume of the drinking cup 10. It will be appreciated that the food substance/ingredient 22 may be provided in loose, granulated or powder form, or alternatively in a compressed pellet or block form, the format selected depending on the mixing characteristics of the selected beverage as well as attending to the manufacturing characteristics of the combined drinking cup 10 and frame 20. Alternatively, a loose supply of the food substance/ingredient 22 to be mixed may be received and contained within the concavity of the drinking cup 10 without the frame 20.

Also according to the invention, condiments such as sugar, creamer or the like may be provided either within the same frame 20 as the selected food substance/ingredient 16 or in one or more separate frames 20 also placed in and optionally secured to an interior surface of drinking cup 10. Plural frames 20 may be joined together or even fabricated in an integral structure with plural receiving cavities to receive a like number of ingredients 16.

With reference now to FIG. 2, a second embodiment of the present invention includes drinking cup 30 shown provided with a flow-through frame or pouch 31, with a plurality of inwardly extending tabs 32 (two shown) positioned at the same intermediate height of an interior wall 33 of the drinking cup 30, the wall 33 extending upwardly from a floor 35 in the manner previously described. A sealing lid 34 is sized and shaped to comport with the inner dimensions of the drinking cup 30 at that intermediate height, and supported by tabs 32 to sealingly enclose the contents of the drinking cup 30 contained within the volume defined between the floor of the drinking cup 30 and the sealing lid 34. Optionally, and as will be apparent to the skilled artisan, the sealing lid 34 may be temporarily sealed to the drinking cup 30 with an edible, frangible barrier or coating for further assuring freshness of the ingredient 16, thereby providing an extended shelf life prior to use. Such seal may also be achieved as a vacuum seal. A removal tab 36 is secured to one planar side 38 of the sealing lid 34, and optionally is foldable to a position substantially parallel to planar side 38. Removal tab 36 may also be provided with an increased length to extend beyond and overlap the upper periphery of drinking cup 30 in the unused condition to provide further handling convenience.

In this embodiment, the distal end of the tab will be visible even when a plurality of drinking cups 30 are provided in a stacked arrangement. Tabs 32 in concert support the sealing lid 34 to serve two functions. First, the sealed structure of the sealing lid 34/drinking cup 30 serves to protect the partial interior of the drinking cup 30 and ingredient 16 in a fresh, ready-to-use state. Second, the planar side 38 of the sealed structure provides a floor for receiving the bottom portion of a second drinking cup 30 in nested arrangement, to enable stacking of a plurality of drinking cups 30 prior to or subsequent to use in the manner described above, thereby further minimizing storage space requirements.

Since the typical drinking cup 30 is relatively lightweight, the lid 34 in its fully installed sealing arrangement will readily support the weight of a plurality of additional stacked cups 30, and may be either self-supporting or amenable to installation in conventional drinking cup dispensers. Optionally, and to provide further weight-bearing capability, one or more standoffs or legs 37 extend downwardly from the underside of sealing lid 34 to locate the lid in its fully installed sealing condition, and to support a stack of drinking cups 30 nested therein. Although the standoffs or legs 37 are shown to be positioned radially outwardly from a concurrent central vertical axis of the dispensing cup 30 and sealing lid 34, it is further contemplated that one or more legs 37 may be sized and shaped to mate or conform with a solid frame 31 to provide structural support to the drinking cup 30/sealing lid 34/frame 31 assembly, whether the leg(s) is located coincident with or off-center from the central vertical axis. It will be further appreciated that sealing lid 34 may be generally dome-shaped to received frame or pouch contained ingredient, or loose ingredient, such that the lower edges of the concavity thereof rest on and are brought into sealing engagement with the floor 14, rather than the walls 12, of any disposable drinking cup included in the system of the present invention.

The ingredient 16 may be provided in an alternate frame such as a flow-through pouch 31 such as that conventionally used for instant coffee and instant tea, the pouch 31 being either secured or unsecured to the floor of the drinking cup 30, but in any case provided in combination with the drinking cup 30. Alternatively, the frame 20 shown in FIG. 1 may be used in connection with the drinking cup 30 of the second embodiment shown in FIG. 2, having a height in the installed position at or below the height of the fully installed sealing lid 34, and thus providing support for a plurality of drinking cups 30 provided in a stacked arrangement.

With reference now to FIG. 3 and according to a third embodiment of the present invention, a drinking cup 40 has a supporting annular ring 42 extending at a common, intermediate height about an interior surface of wall 44 extending from floor 46 of drinking cup 40, the annular ring 42 receiving a sealing lid 48 in sealing relationship therefor in the manner previously described. Similarly, a removal tab 50 is secured to one planar side 52 of the sealing lid 48, and optionally is foldable to a position substantially parallel to planar side 52.

It will be appreciated that according to either embodiment shown in FIGS. 2 and 3, the sealing lid 34, 48 may be readily reinstalled in sealing arrangement following consumption of some (at least to a level below tabs 32, or annular ring 42) or all of a beverage brewed therein, thereby providing a spill-free disposal means, and successfully addressing and overcoming a long felt but heretofore unaddressed need in the related art.

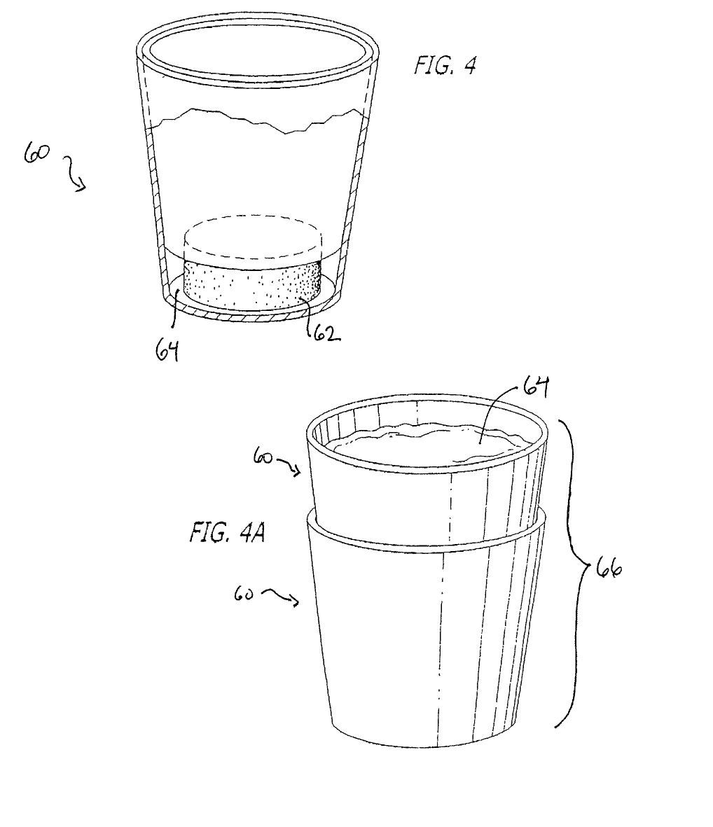

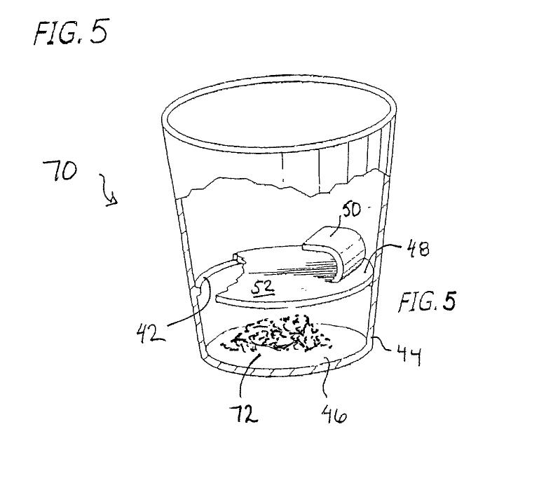

With reference now to FIGS. 4 and 4A, it will be seen that for a given drinking cup 60 of any of the embodiments described above, an open frame (shown representatively as a disc-like hollow body 62) is disposed on and preferably secured to the interior floor 64 of the drinking cup sized and shaped to support another like-sized and shaped drinking cup in nested relationship to minimize the overall stacked height of a plurality of such drinking cups. It is further shown in FIGS. 4 and 5 that frame 62 may be sized and shaped in a manner necessary and desirable to accommodate, and optionally maximize, mixing of an ingredient with a mixing fluid 64, while maintaining an overall profile suitable to minimizing the overall stacked height of an assembly 66 of drinking cups 60, and securing residual contents with or without a sealing lid following substantial consumption of the mixed beverage.

With reference to FIG. 5, it will be seen that drinking cup 70 may utilize the sealing lid 48 to capture in sealing arrangement at the bottom of drinking cup 70 an appropriate quantity of a loose mixable ingredient 72 to be reconstituted in the manner previously described, although without the structural container of frame 20 or pouch 31 previously described. Alternatively, ingredient 72 may be provided in a self-supporting disc or tablet, without benefit or frame 20 or pouch 31, that is soluble with a diluent such as water or other mixer in the manner previously described. It will be appreciated that the quantity of ingredient 72 selected will be proportioned as necessary to provide the desired concentration of the mixture or reconstituted beverage following introduction of the liquid mixer. Depending on the quantity of the loose mixable ingredient 72 or height of self-supporting disc or tablet, the sealing lid 48 may be sized to be received at an intermediate height within the drinking cup 70 to completely receive the ingredient 72, while providing any, or no, additional open space thereabove. By this arrangement, a plurality of drinking cups 70 may be received in stacking arrangement with a predetermined packing density, to determine an overall height of the stacked assembly of drinking cups 70 in the manner described above in connection with FIG. 4A.

It is to be understood that the present invention is not limited to the embodiments described above, but encompasses any and all embodiments within the scope of the following claims.

I claim:

1. A personal beverage mixing system for providing an individual serving of a beverage in combination with a liquid mixer, the mixing system comprising:
a drinking vessel having a floor and a wall extending therefrom defining a mixing chamber; and
a frame adapted to receive a mixable ingredient, the frame enabling inflow and outflow of the liquid mixer therethrough to mix with the ingredient and produce a mixed beverage thereby within the mixing chamber, the frame provided within the concavity of the drinking vessel.

2. The personal beverage mixing system as recited in claim 1, wherein the mixing system is disposable.

3. The personal beverage mixing system as recited in claim 2, wherein the drinking vessel is an individual serving size drinking cup.

4. The personal beverage mixing system as recited in claim 1, wherein the frame is secured within the concavity of the drinking vessel.

5. The personal beverage mixing system as recited in claim 4, wherein the frame is integrally formed with the drinking vessel.

6. The personal beverage mixing system as recited in claim 1, further comprising a sealing lid for sealing a volume of the concavity of the drinking vessel.

7. The personal beverage mixing system as recited in claim 6, the sealing lid further comprising at least one weight-bearing leg engagable with floor of the drinking vessel.

8. The personal beverage mixing system as recited in claim 7, wherein the weight-bearing leg is engagable with the frame.

9. The personal beverage mixing system as recited in claim 6, further comprising a protrusion extending inwardly from the wall of the drinking vessel to support the sealing lid in a sealing condition therebetween.

10. The personal beverage mixing system as recited in claim 9, wherein the protrusion is located at an intermediate height of the wall.

11. The personal beverage mixing system as recited in claim 9, wherein the protrusion is selected from the group including at least one tab, shoulder, and annular ring.

12. The personal beverage mixing system as recited in claim 9, wherein the sealing lid, protrusion , and a top surface of the frame are substantially coplanar in the fully installed and sealed condition.

13. The personal beverage mixing system as recited in claim 1, wherein the ingredient is selected from the group including granules, powders, gels, and liquids.

14. The personal beverage mixing system as recited in claim 1, wherein the frame includes at least one ingredient-receiving chamber for receiving at least a like number of ingredients.

15. The personal beverage mixing system as recited in claim 14, wherein the ingredients are selected from the group including coffee, tea, hot chocolate, fruit drink mix, vegetable drink mix, and broth bullion.

16. The personal beverage mixing system as recited in claim 14, wherein the ingredients are selected from the group of condiments including sugar, sugar substitute, creamer, creamer substitute, and spices.

17. A personal beverage mixing system for mixing an individual serving of a beverage constituted with a liquid mixer, the mixing system comprising:
a drinking vessel having a floor and a wall extending therefrom;
a mixable ingredient prepackaged with the drinking vessel for mixing with the liquid mixer to produce a mixed beverage thereby; and
a sealing lid for sealing a volume of the concavity and containing the mixable ingredient therein.

18. The personal beverage mixing system as recited in claim 17, wherein the mixing system is disposable.

19. The personal beverage mixing system as recited in claim 17, wherein the drinking vessel is an individual serving size drinking cup.

20. The personal beverage mixing system as recited in claim 17, wherein the sealing lid seals the volume at an intermediate extent of the drinking vessel to fully encapsulate and secure the mixable ingredient.

21. A beverage mixing system for providing at least one serving of a beverage in combination with a liquid mixer, the mixing system comprising:
a drinking vessel having a floor and a wall extending therefrom defining a mixing chamber; and
a serving of a mixable ingredient proportional to the capacity of the mixing chamber provided within the mixing chamber, to be mixed with the liquid mixer and produce a mixed beverage thereby within the mixing chamber.

22. The personal beverage mixing system as recited in claim 21, wherein the mixable ingredient is loosely provided in the drinking vessel.

23. The personal beverage mixing system as recited in claim 21, wherein the mixing system is disposable.

24. The personal beverage mixing system as recited in claim 2, wherein the drinking vessel is an individual serving size drinking cup.

25. The personal beverage mixing system as recited in claim 21, further comprising a sealing lid for sealing a volume of the concavity of the drinking vessel.
